(19) United States
(12) Patent Application Publication
(10) Pub. No.: US 2023/0322007 A1
(43) Pub. Date: Oct. 12, 2023

(54) PRE-TREATMENT FLUID APPLICATION IN PRINTING SYSTEMS

(71) Applicant: Hewlett-Packard Development Company, L.P., Spring, TX (US)

(72) Inventors: Pau COSTAL FORNELLS, Sant Cugat del Valles (ES); Andreas MÜLLER, Sant Cugat del Valles (ES); Alexandre RODRIGUEZ LLOFRIU, Sant Cugat del Valles (ES)

(73) Assignee: Hewlett-Packard Development Company, L.P., Spring, TX (US)

(21) Appl. No.: 18/042,803

(22) PCT Filed: Aug. 27, 2020
(86) PCT No.: PCT/US2020/048150

§ 371 Date: Feb. 24, 2023

(51) Int. Cl. B41M 5/00

(52) U.S. Cl. CPC B41M 5/0017

(57) ABSTRACT

A printing system may be provided and the printing system may comprise, in an example, a controller, wherein the controller may cause a printing mechanism to selectively apply pre-treatment fluid and marking fluid on a recorded medium. The printing mechanism may comprise a first printhead to dispense pre-treatment fluid and a second printhead to dispense marking fluid, wherein the first printhead is arranged in line with the second printhead. The controller may cause the printing system to enter a first print mode, wherein in the first print mode, there are a plurality of passes of a printing mechanism where pre-treatment fluid and/or marking fluid is applied to the recorded medium, and wherein a first of the plurality of passes is to be of the pre-treatment fluid from the first printhead without the second printhead dispensing marking fluid.

### BACKGROUND

Images are processed for use with computing machines, such as a printing device. A printing device may form part of a printing system and may comprise a print carriage with a plurality of printheads for the purpose of reproducing a physical representation of an image on a recorded medium.

A physical representation of an image may be reproduced by a printing device by dispensing marking liquid (or coloured ink) on the recorded medium. The printing device may also use a pre-treatment liquid to enhance the interaction between the marking liquid and the recorded medium (ink-on-media interaction), and to prevent the marking liquid from migrating, bleeding or coalescing.

A print carriage of a printing device may be provided with a specific arrangement of printheads, where each printhead may be assigned to dispense one or more of a plurality of marking liquids, or pre-treatment liquid.

### BRIEF DESCRIPTION OF THE DRAWINGS

FIG. 1 is an example printing system and an example print pass representation of the printing system according to the present disclosure.

FIG. 2 is a schematic diagram showing components of a controller according to an example.

FIG. 3 is a flow diagram showing a first method of applying pre-treatment liquid and marking liquid according to an example.

FIG. 4 is a view of an example print pass representation of a printing system according to an example.

FIG. 5 is a view of an example print pass representation of a printing system performing the method of FIG. 3 according to an example.

FIG. 6 is a flow diagram showing a second method of applying pre-treatment liquid and marking liquid according to an example.

FIG. 7 is a view of an example print pass representation of a printing system according to an example.

FIG. 8 is view of an example print pass representation of a printing system performing the method of FIG. 6 according to an example.

FIG. 9 is an example of a computer readable medium comprising instructions to perform virtual staggering on a printing system according to an example.

### DETAILED DESCRIPTION

In order to reproduce a physical representation of an image such as a digital image on a recorded medium, a printing mechanism of a printing system may comprise a print carriage that is controllable to be moved across a scan axis of a printing device that forms part of the printing system in a controlled movement. This movement of the print carriage is referred to as a pass. During a pass of the print carriage, the print carriage is controllable to dispense fluid on the recorded medium via printheads disposed on the print carriage. The fluid may be dispensed through nozzles on the printheads. During each pass, a number of nozzles may be selected to dispense the fluid on the recorded medium, and the distance from the first to the last nozzle that dispenses fluid can be referred to as a print swath. The fluid that is dispensed may be marking liquid and/or pre-treatment liquid. Between each pass, the printing system can be controlled to cause the recorded medium to perform a stepwise movement in a predetermined direction (direction of advance) and distance. This movement of the recorded medium can be referred to as a media advance and the movement of the recorded medium can be caused by the driving mechanism of the printing system. The driving mechanism may comprise a motor which can be selectively controlled. After a plurality of passes and media advances, the printing system may reproduce the physical representation of an image on the recorded medium by successively producing bands of the image on the recorded medium, where a band is a completed section of the image having a height and width and the height corresponds to the print swath distance.

An example printing system may have one or a plurality of print modes. The print mode may determine how many passes of the print carriage are used to form a printed area on the recorded medium. The printed area may represent a single band of the physical representation of an image on the recorded medium. In an example, a printing system may have a six pass print mode. In a six pass print mode, the printing system may perform six passes of the print carriage to form a single band of the physical representation of an image on the recorded medium. A printing system may comprise a plurality of modes and each mode may comprise a different number of passes and/or a different selection of printheads to be used during each pass.

An example printing system may also comprise a print mask. A print mask may be used to control the firing sequence of nozzles in a print head in a multi pass print mode and can assist in defining how the marking liquid and/or pre-treatment liquid is to be distributed on the recorded medium. A print mask may indicate on which sections of the printed area the marking liquid and/or pre-treatment liquid are to be dispersed during each pass or the pass on which marking liquid and/or pre-treatment liquid is to be ejected. In an example, the digital representation of the image may be formed of a plurality of pixels. In this example, the print mask may indicate which sections of the printed area of the physical representation of the image represent these pixels, and may indicate which of these sections the marking liquid and/or pre-treatment liquid is to be dispersed during each pass.

In an example printing system, a print mode may comprise instructions to dispense a layer of pre-treatment liquid on a recorded medium, followed by a layer of marking liquid, wherein the marking liquid is dispensed to interact with the pre-treatment liquid. The pre-treatment liquid used may be an optimiser. The optimiser can promote ink-on-media interaction by preventing the marking liquid from migrating, bleeding or coalescing, thus allowing for higher quality reproductions of the physical representation of an image on the recorded medium and higher throughput. This may also allow for a faster reproduction of the image due to a reduction of irregularities in the reproduced image.

The optimiser can take a predetermined amount of time to settle and dry on/be absorbed by the recorded medium before the marking liquid is dispensed to interact with it. A property of the recorded medium such as the absorbency of the recorded medium may also influence the time taken for the optimiser to settle and dry on/be absorbed by the recorded medium. A printing system may comprise a print carriage with a printhead layout where the optimiser printhead(s) is positioned within the print carriage along the same axis as the marking liquid printheads in an in-line printhead arrangement. In this arrangement, the optimiser and marking liquid may be dispensed on the recorded medium during the same pass of the print carriage, thus the optimiser may not have adequate amount of time to dry on/be absorbed by the recorded medium before the marking liquid is dispensed over it.

The following description is directed to various examples of the disclosure in which a printing system is provided with a print carriage comprising at least an in-line printhead arrangement of a pre-treatment liquid and a marking liquid. The following examples describe print modes to allow printing systems with print carriages comprising in-line printhead arrangements of a pre-treatment liquid and a marking liquid to disperse exclusively pre-treatment liquid in a first pass without marking liquid, and then pre-treatment liquid and/or marking liquid in subsequent passes. With such a configuration, a virtual staggering of the printheads may be achieved without changing the physical arrangement or orientation of the printheads.

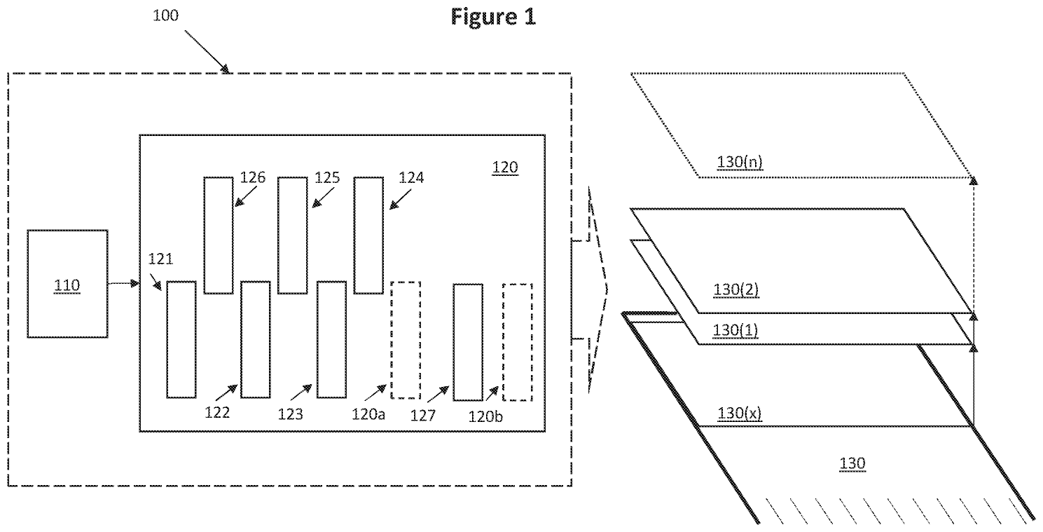

With reference to FIG. 1, there is shown an example printing system 100 according to the present disclosure. The printing system 100 comprises a controller 110 and a print carriage 120.

The print carriage 120 may comprise a plurality of printheads to dispense pre-treatment liquid and marking liquid. In the example shown, the print carriage 120 comprises six marking liquid printheads 121-126, and a pre-treatment liquid printhead 127 disposed on the print carriage in line with the marking liquid printheads 121, 122, 123. The plurality of marking liquid printheads 121, 122, 123 are arranged in line along a first axis on which the pre-treatment liquid printhead is arranged. The print carriage 120 is not limited to six marking liquid printheads and a pre-treatment liquid printhead. As shown by the extra marking liquid printhead 120a and extra pre-treatment liquid printhead 120b, in other examples, the print carriage 120 may comprise any number of marking liquid printheads and pre-treatment liquid printheads as long as a first pre-treatment liquid printhead is in an in-line printhead arrangement with a first marking liquid printhead.

The printing system 100 may comprise a plurality of print modes which, when entered by the printing system 100, causes the controller 110 to instruct the print carriage to selectively apply pre-treatment fluid and marking fluid to reproduce a physical representation of an image on a recorded medium 130. In an example, the printing system 100 may comprise a print mode, wherein the print mode does not utilise virtual staggering. In an example, when the printing system 100 enters a print mode, the controller 110 may instruct the print carriage 120 to perform n number of passes 130(1)-130(n) to selectively apply pre-treatment fluid and marking fluid to reproduce a physical representation of an image on a recorded medium 130. The selected print mode may not include virtual staggering of the printheads, therefore, the pre-treatment fluid which may be optimiser and marking fluid which may be coloured ink may be dispensed on the recorded medium during the same pass of the print carriage.

In another example, the print mode of the printing system 100 may have a corresponding first print mode, wherein the first print mode includes virtual staggering of the printheads. When the printing system 100 enters the first print mode, the controller 110 may instruct the print carriage 120 to perform a first pass 130(x) formed of pre-treatment liquid without marking liquid being dispensed from any of three inline printheads 121, 122, 123, prior to performing the subsequent passes of the plurality of passes 130(1)-130(n) of the corresponding print mode of the printing system 100. It should be noted that 130(x) and 130(1)-130(n) represent schematically a pass that may be performed by a print carriage across a recorded medium 130. In one example with the printhead configuration shown in FIG. 1 where in a print mode it is desired to provide marking liquid in six passes (n=6), when the printing system 100 enters the first print mode, the number of passes or steps may be increased by one (n+1=7) to accommodate the extra pass where pre-treatment liquid is applied without marking liquid. In that case, the distance by which the recorded medium advances may be reduced to cater for the extra steps needed to complete the portion of the image (described in more detail later in reference to FIG. 5). In another example with the printhead configuration shown in FIG. 1, where in the print mode the number of passes to form a physical representation of a portion of the image is six (n=6), when the printing system 100 enters the first print mode, the number of passes may be kept the same (n=6), however the first of the six passes is a pass consisting of pre-treatment liquid without other liquids, and five other passes where marking liquid is applied. In this example the density of marking liquid applied in one, some or all of the five other passes is increased based on a print mask (described in more detail later in reference to FIG. 8).

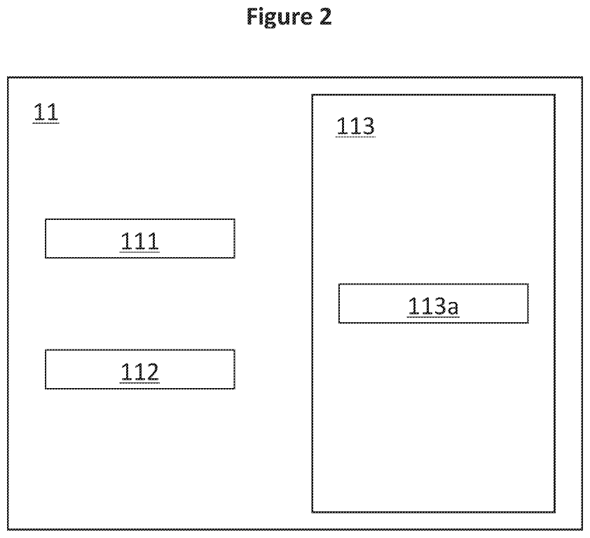

With reference to FIG. 2, the controller 110 may comprise a plurality of components, some of which are described below. The controller may be a programmable logic device (PLD) or other computing device that can carry out instructions. The controller may include one or multiple processing elements that are integrated in a single device as described in the example below or distributed across devices.

The controller 110 of the printing system 100 may comprise a data input/output interface unit 111. In an example the input/output interface unit 111 may receive input data from external components, for example, user input devices (not shown) to allow a user to interact with the system 100 and, for example, select a print mode such as the first print mode. The input/output interface unit 111 may also output data from the controller 110 to external components, for example, such as a display unit (not shown).

The controller 110 may further comprise a processor 112 to manage all the components within the controller 110, and process all data flow between the components within the controller 110. The processor may be any of a central processing unit, a semiconductor-based microprocessor, an application specific integrated circuit (ASIC), and/or other device suitable for retrieval and execution of instructions.

The controller 110 may further comprise a storage or memory unit 113 to store any data or instructions which may need to be accessed by, for example, the processor 112. The memory unit 120 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

Referring to FIGS. 1 and 2, in one example, the memory unit 113 may include instructions to cause the processor 112 to carry out actions. The instructions may comprise a method 113a and the method may initiate a printing mechanism to apply a pre-treatment liquid using a first printhead and a marking liquid using a second printhead on a printed area of a recorded medium. The first printhead and second printhead may be movable along a first axis and spaced relative to each other along the axis in an in-line printhead arrangement. The printed area is to be formed of layers of the pre-treatment liquid and/or marking liquid applied on the recorded medium, and the first of the layers is formed of pre-treatment liquid from the first printhead in a first pass of the print carriage. There may a plurality of second printheads that can apply marking liquid arranged in line along the first axis and none of the second printheads dispense marking liquid to form the first of the layers in the first pass.

The controller 110 may be located in a printing device which is part of the printing system 100, and the printing device may comprise the print carriage 120. The controller is not limited to being located in a printing device. The controller 110 may be located in any location where data can be processed or instructions can be carried out and instructions can be sent to the printing device, for example, located in a cloud computing network.

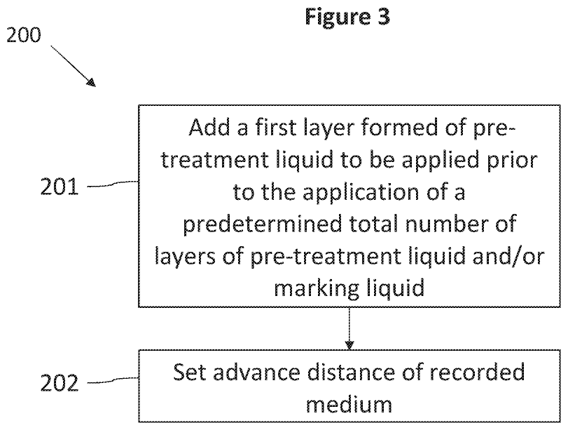

Reference is now made to FIG. 1 and FIG. 3 which shows a first method 200 of performing virtual staggering for the printing system 100 with the print carriage 120 comprising an in-line printhead arrangement where there may be one printhead or a plurality of printheads that are to simultaneously dispense marking liquid arranged in line with a printhead that is to dispense pre-treatment liquid. In an example, the printing system 100 may include a print mode which does not utilise virtual staggering, and a corresponding first print mode which utilises virtual staggering. The method 200 may be selectable as the first print mode on the printing system 100.

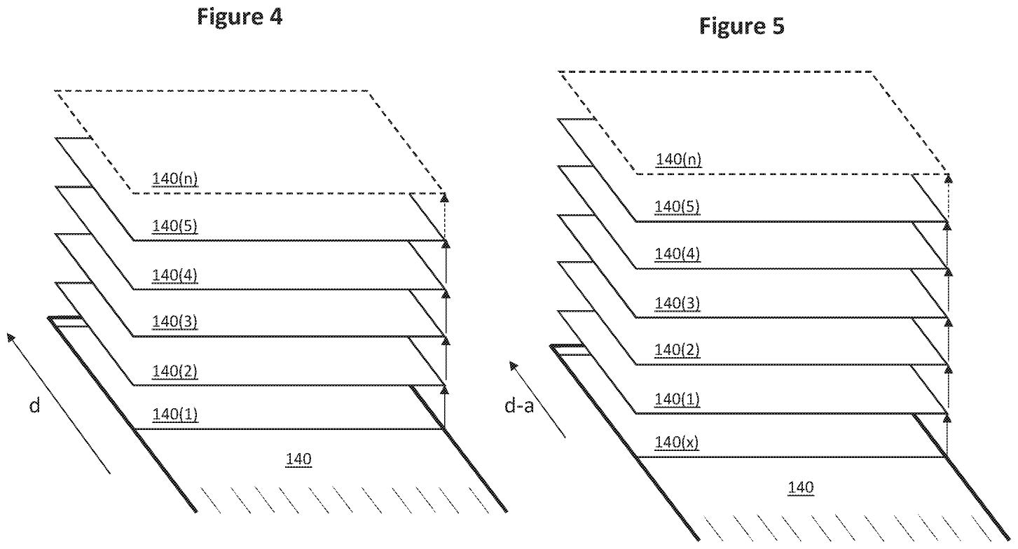

Reference is also made to FIG. 4 which shows an example print pass representation of a first printing system 100 in the print mode which does not comprise virtual staggering, and which includes n number of passes and an advance distance d. Further reference is made to FIG. 5 which shows an exploded view of an example print pass representation of the printing system 100 in the first print mode which carries out the method 200.

Method 200 at block 201 adds a first layer formed of pre-treatment liquid prior to the application of a predetermined total number of layers of pre-treatment liquid and/or marking liquid. When the printing system 100 has entered the first print mode, the controller 110 may instruct the print carriage 120 of the printing system 100 to perform a first pass of pre-treatment liquid without marking liquid 140(x) prior to performing the passes 140(1)-140(n) of the corresponding print mode, thus increasing the number of passes of the corresponding print mode by one. Referring to FIG. 4, the passes 140(1)-140(n) which are schematically shown in an exploded view layered one-on-top of each other on a recorded medium 140 of a printing system 100 represent a print mode comprising passes 1 to n without a pass where pre-treatment liquid is exclusively dispensed during a pass. In such a print mode where, for example, there are six passes, the first to third passes may each include a pre-treatment liquid and marking liquid being dispensed, and fourth to sixth passes may each include marking liquid being dispensed without pre-treatment liquid. In the first print mode, the controller 110 may instruct the print carriage 120 to perform a first pass 140(x) of pre-treatment liquid without marking liquid on the recorded medium 140 prior to the application of the layers of pre-treatment liquid and/or marking liquid during passes 140(1)-140(n). This additional initial pass of exclusively pre-treatment liquid maintains the total number of passes in which marking liquid is applied compared to the print mode of FIG. 4 but increases the passes to seven 140(x), 140(1)-140(n) in order to complete a single band. In such a configuration, the advance distance of the recorded medium which may be based on the speed at which the system is able to move the recorded medium 140 through the scanning system while assuring proper ink laydown, may be adjusted, and in this example, may be reduced.

In block 202, method 200 comprises setting the advance distance of the recorded medium in the first print mode and this may include an adjustment of the distance compared to, for example, in the print mode related to FIG. 4. When the printing system 100 has entered the first print mode, the controller 110 may instruct a driving mechanism of the printing system 100 to set the distance d based on the n number of passes of the corresponding print mode which does not utilize virtual staggering. In an example, in order to accommodate the additional first pass of pre-treatment liquid without marking liquid 140(x), when the printing system 100 has entered the first print mode, the controller 110 may instruct the driving mechanism to perform a reduced advance distance d-a shown in FIG. 5. In an example, the controller 110 may determine how much the advance distance is to be adjusted by using the reduction factor:

$$a = d \frac{P}{( P + 1 )} \qquad ( 1 )$$

Where P is the number of passes in the corresponding print mode which does not utilize virtual staggering as shown in FIG. 4.

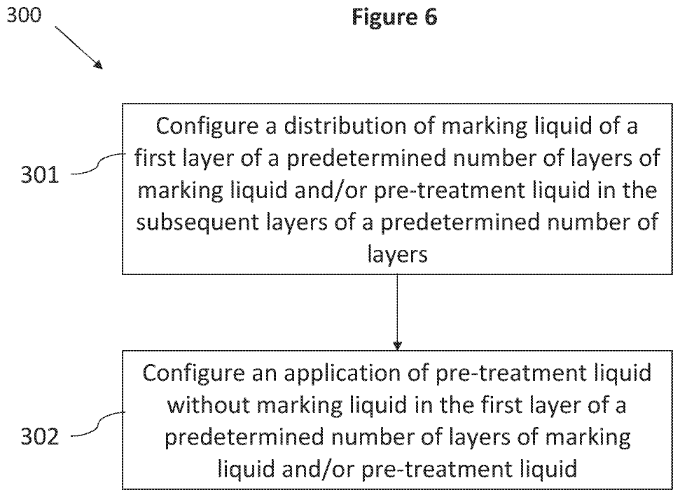

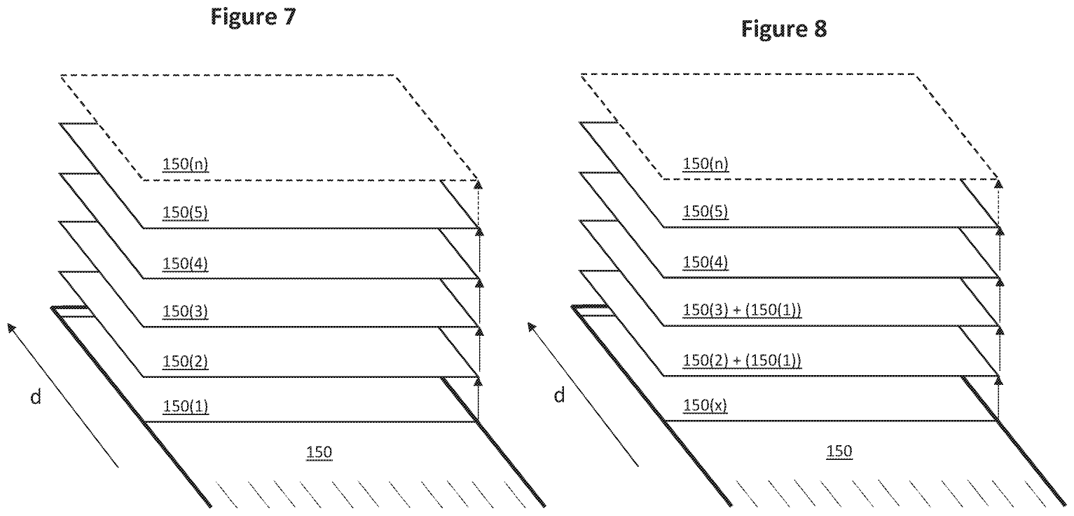

Reference is now made to FIG. 6 which shows a second method 300 of performing virtual staggering for a printing system 100 with a print carriage 120 comprising an in-line printhead arrangement where there may be one printhead or a plurality of printheads that are to simultaneously dispense marking liquid arranged in line with a printhead that is to dispense pre-treatment liquid. In an example, the printing system 100 may include a print mode which does not utilise virtual staggering, and a corresponding print mode which utilises virtual staggering. The method 300 may be selectable as an alternative first print mode on the printing system 100 to the method 200 or selectable as an additional second print mode to the print mode that includes the method 200. Reference is also made to FIG. 7 which shows an example print pass representation of first printing system 100 not utilising virtual staggering, and which includes n number of passes. Further reference is made to FIG. 8 which shows an example print pass representation of printing system 100 in the first print mode which carries out the method 300.

Method 300 includes block 301 of configuring a distribution of marking liquid of a first layer of a predetermined number of layers of marking liquid and/or pre-treatment liquid in subsequent layers of the predetermined number of layers. The printing system 100 may include a print mask which shows the distribution of marking liquid and/or pre-treatment liquid which is to be applied during each pass. Referring to FIG. 7, the passes 150(1)-150(n) represented schematically layered one-on-top of each other on a recorded medium 150 of the example printing system 100 in the print mode which does not utilise virtual staggering, represent a print mode comprising passes 1 to n. The print mask of the printing system 100 may show the distribution of marking liquid and/or pre-treatment liquid which is to be applied during each of the n number of passes. When the printing system 100 has entered the first print mode, the controller may instruct the print carriage 120 of the printing system 100 to apply the distribution of marking liquid in the first pass 150(1) during the subsequent passes 150(2)-150(n), thus increasing the density of marking liquid in one, some or all of the subsequent passes. An example of this is shown in FIG. 8 where the subsequent passes 150(2) and 150(3) of the print mode in FIG. 7 are now 150(2)+(150(1)) and 150(3)+(150(1)) respectively in the first print mode of FIG. 8 such that a larger density of marking liquid based on marking liquid that would have been applied in the first pass without virtual staggering is applied in the second 150(2) and third 150(3) passes compared to pass 150(4) and 150(5). In an example, the controller may instruct the print carriage 120 to apply the marking liquid of the first pass 150(1) during the next subsequent pass, for example 150(2). In another example, the controller 110 may instruct the print carriage 120 to apply the pre-treatment liquid and/or marking liquid of the first pass 150(1) across all or some of the next subsequent passes 150(2)-150(n).

Once the distribution of marking liquid of the first layer of a predetermined number of layers of marking liquid and/or pre-treatment liquid has been configured to be applied in the subsequent layers of the predetermined number of layers, method 300 moves to block 302—configure an application of pre-treatment liquid without marking liquid in the first layer of a predetermined number of layers of marking liquid and/or pre-treatment liquid. When the printing system 100 has entered the first print mode, the controller 110 may instruct the print carriage 120 of the printing system 100 to apply pre-treatment liquid without marking liquid in the first layer of the predetermined number of layers of marking liquid and/or pre-treatment liquid An example of this is shown in FIG. 8 where the first pass of marking liquid and pretreatment liquid 150(1) of FIG. 7 in the print mode without virtual staggering is now a first pass in the first print mode of pre-treatment liquid without marking liquid 150(x) of FIG. 8.

In an example, the method 300 may be performed in a different order. The configurations of blocks 301 and 302 may be performed by the printing system 100 in an alternative sequence or concurrently.

In the first print mode example shown in FIG. 8 where a six pass print mode is selected, the controller 110 will receive data to indicate that a particular print mode that includes six passes with virtual staggering has been selected, and the controller will obtain instructions to carry out the sequence of passes as referred to above and shown in relation to FIG. 8. In the example of FIG. 8, the instructions will cause the printing carriage to carry out a first pass 150(x) which will include pre-treatment liquid exclusively being dispensed onto record medium 150. The instructions may define the action to the taken by the printing system include nozzles and/or print heads in the printing carriage and a driving mechanism that causes movement of the recorded medium 150. The instructions may cause the driving mechanism to cause movement of the recorded medium by a distance d in between passes. The instructions may cause the printing carriage to perform second and third passes which will include applying pre-treatment liquid and marking liquid. The instructions may then cause the printing carriage to perform fourth to sixth passes which will include applying marking liquid without pre-treatment liquid. In other examples where a first print mode to be selected may include number of passes, n, that is less than or greater than six, the instructions may be similar to the six pass mode where there is a pass that is exclusively of pre-treatment liquid without marking liquid such as in a first pass of the n pass print mode, and further passes of the n pass print mode where pre-treatment liquid and marking liquid or marking liquid alone is applied in the further passes. The configuration in relation to the method described above in relation to the first print mode example of FIG. 3 or FIG. 6 can be applied to a different number of passes and a printing system may comprise a number of print modes each relating to a different number of passes represented by a user-selectable identifier on the printing system.

In an example, each print mode may have a number of types such as a user-selectable type without virtual staggering for a predetermined number of passes and another user-selectable type with virtual staggering for the predetermined number of passes according to any of the examples described above. In one example, wherein the predetermined number is six such that there is a six pass print mode, there may be a user selectable type with virtual staggering and a related user selectable type without virtual staggering for that six pass print mode. In another example, wherein the predetermined number is five such that there is a five pass print mode, there may be a user selectable type with virtual staggering and a related user selectable type without virtual staggering for that five pass print mode.

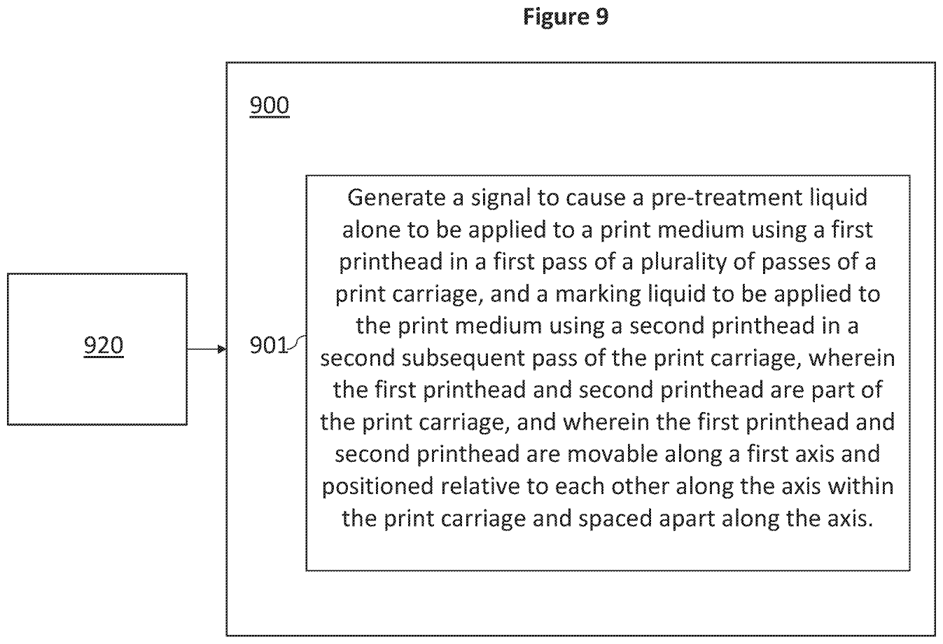

FIG. 9 shows a memory 900, which is an example of a computer readable medium storing instructions that, when executed by a computing device such as a processor 920, may cause the processor 920 to carry out any of the aforementioned methods. In an example, the computer readable medium stores an instruction 901 to cause the processor 920 to generate a signal to cause a pre-treatment liquid alone to be applied to a print medium using a first printhead in a first pass of a plurality of passes of a print carriage, and a marking liquid to be applied to the print medium using a second printhead in a second subsequent pass of the print carriage, wherein the first printhead and second printhead are part of the print carriage, and wherein the first printhead and second printhead are movable along a first axis and positioned relative to each other along the axis within the print carriage and spaced apart along the axis. The computer readable medium may be any form of storage system capable of storing executable instructions, such as a non-transient computer readable medium, for example Random Access Memory (RAM), Electrically-Erasable Programmable Read-Only Memory (EEPROM), a storage drive, an optical disc, or the like.

In an example, the instructions may cause the computing device to obtain a predetermined number of passes of the print carriage, wherein the print carriage is to apply a layer pre-treatment liquid and/or marking liquid on the print medium in each pass of the predetermined number of passes, and generate a signal to cause the application of the pre-treatment liquid alone in a further pass prior to the application of the pre-treatment liquid and/or marking liquid that is to be applied in the obtained predetermined number of passes of pre-treatment liquid and/or marking liquid. Further, the computing device may generate a signal to cause a media advance based on the total number that results from the sum of the predetermined number of passes and the further pass.

In another example, the instructions may cause the computing device to obtain a predetermined number of passes of the print carriage, wherein the print carriage is to apply a pre-treatment liquid and/or marking liquid on the print medium in each pass; obtain a print mask showing a distribution of pre-treatment fluid and/or marking fluid to be applied on each of the obtained predetermined number of passes; and generate a signal to apply the distribution of pre-treatment fluid and/or marking fluid to be applied on a first of the obtained predetermined number of passes in the subsequent passes of the obtained predetermined number of passes, and to cause the application of the pre-treatment alone on the first of the obtained predetermined number of passes.

1. A printing system comprising a controller, wherein the controller is to:
cause a printing mechanism to selectively apply pre-treatment fluid and marking fluid to form a print swath on a recorded medium, wherein the printing mechanism comprises a first printhead to dispense pre-treatment fluid and a second printhead to dispense marking fluid, wherein the first printhead is arranged in line with the second printhead, and
cause the printing system to enter a first print mode, wherein in the first print mode, there are a plurality of passes of the printing mechanism where pre-treatment fluid and/or marking fluid is applied to the recorded medium, and wherein a first of the plurality of passes is to be of the pre-treatment fluid from the first printhead without the second printhead dispensing marking fluid.

2. The printing system of claim 1, wherein the controller is to obtain information relating to a plurality of print modes that can be executed on the printing system, the information including the number of passes, n, of a print mode of the plurality of print modes, and wherein when the printing system enters the first print mode the controller is to cause the printing mechanism to apply n+1 number of passes, and wherein the first of the n+1 number of passes is the first of the plurality of passes which is to be of the pre-treatment fluid without marking fluid.

3. The printing system of claim 2, wherein the controller is to instruct a driving mechanism to cause a media advance of the recorded medium in-between each pass, wherein an advance distance d of the recorded medium during the media advance is based on the n+1 number of passes when the printing system enters the first print mode.

4. The printing system of claim 1, wherein the controller is to obtain information relating to a plurality of print modes that can be executed on the printing system, the information including:
the number of passes, n, of a print mode of the plurality of print modes;
a distribution of pre-treatment fluid and/or marking fluid to be applied on each of the n number of passes; and
wherein when the printing system enters the first print mode the controller is to cause the printing system to apply the distribution of marking fluid of a first of the n number of passes in other passes of the n number of passes, and apply the first of the plurality of passes which is to be of the pre-treatment fluid without marking fluid as the first of the n number of passes.

5. The printing system of claim 1, wherein the printing system further comprises a display, and the controller is to cause the generation of data on the display that indicates a plurality of types of print modes for a predetermined number of passes that are executable by the printing mechanism.

6. The printing system of claim 1, wherein the printing mechanism comprises a print carriage, wherein the print carriage includes a plurality of printheads including the first printhead to dispense pre-treatment fluid and the second printhead to dispense marking fluid.

7. The printing system of claim 6, wherein the printing carriage includes a plurality of second printheads to dispense marking fluid, each of the plurality of second printheads being arranged in line with the first print head and none of the second printheads are to apply making fluid in the first of the plurality of passes.

8. A method comprising:
applying a pre-treatment liquid using a first printhead and a marking liquid using a second printhead on a printed area of a recorded medium, wherein the first printhead and second printhead are movable along a first axis and spaced relative to each other along the axis, and wherein the printed area is to be formed of layers of the pre-treatment liquid and/or marking liquid applied on the recorded medium, and wherein the first of the layers is formed of pre-treatment liquid from the first printhead.

9. The method of claim 8, wherein the printed area is to be formed by a predetermined, n, number of layers of pre-treatment liquid and/or marking liquid, and wherein the first layer formed of pre-treatment liquid is to be applied prior to the application of the predetermined n number of layers of pre-treatment liquid and/or marking liquid.

10. The method of claim 9, wherein an advance distance of the recorded medium between the application of each layer of pre-treatment liquid and/or marking liquid is based on the predetermined n number of layers, and the first layer formed of pre-treatment liquid is to be applied prior to the application of the predetermined n number of layers.

11. The method of claim 8, wherein the printed area is to be formed by a predetermined, n, number of layers of pre-treatment liquid and/or marking liquid, wherein the distribution of pre-treatment liquid and/or marking liquid to be applied in each of the n number of layers is determined based on a print mask, and wherein the distribution of pre-treatment liquid and/or marking liquid of a first layer of the n number of layers is to be applied in the subsequent passes of the n number of layers, and wherein the first layer formed of pre-treatment liquid is to be applied as the first layer of the n number of layers.

12. A non-transitory computer-readable medium comprising instructions, which when executed on a computing device, causes the computing device to:
generate a signal to cause a pre-treatment liquid alone to be applied to a print medium using a first printhead in a first pass of a plurality of passes of a print carriage, and a marking liquid to be applied to the print medium using a second printhead in a second subsequent pass of the print carriage, wherein the first printhead and second printhead are part of the print carriage, and wherein the first printhead and second printhead are movable along a first axis and positioned relative to each other along the axis within the print carriage and spaced apart along the axis.

13. The non-transitory computer-readable medium of claim 12, wherein instructions when executed on the computing device, further cause the computing device to:
obtain a predetermined number of passes of the print carriage, wherein the print carriage is to apply a layer pre-treatment liquid and/or marking liquid on the print medium in each pass of the predetermined number of passes; and
generate a signal to cause the application of the pre-treatment liquid alone in a further pass prior to the application of the pre-treatment liquid and/or marking liquid that is to be applied in the obtained predetermined number of passes of pre-treatment liquid and/or marking liquid.

14. The non-transitory computer-readable medium of claim 13, wherein instructions when executed on the computing device, further cause the computing device to generate a signal to cause a media advance based on the total number of the predetermined number of passes and the further pass.

15. The non-transitory computer-readable medium of claim 12, wherein instructions which when executed on the computing device, further cause the computing device to:
obtain a predetermined number of passes of the print carriage, wherein the print carriage is to apply a pre-treatment liquid and/or marking liquid on the print medium in each pass;
obtain a print mask showing a distribution of pre-treatment fluid and/or marking fluid to be applied on each of the obtained predetermined number of passes; and
generate a signal to apply the distribution of pre-treatment fluid and/or marking fluid to be applied on a first of the obtained predetermined number of passes in the subsequent passes of the obtained predetermined number of passes, and to cause the application of the pre-treatment alone on the first of the obtained predetermined number of passes.
